(19) United States
(12) Patent Application Publication
(10) Pub. No.: US 2003/0153268 A1
(43) Pub. Date: Aug. 14, 2003

(54) Number dialing kit for mobile phones that are capable of infrared data transmission

(76) Inventor: Huo-Lu Tsai, Taichung Hsien (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/077,011

(22) Filed: Feb. 14, 2002

(51) Int. Cl. H04B 1/38

(52) U.S. Cl. 455/41; 455/557; 455/564; 455/66

(57) ABSTRACT

A number dialing kit for a mobile phone includes a keypad unit and a processor unit. The keypad unit is operable so as to generate a dial number output. The processor unit includes a flow control analyzer, a communications protocol controller and an infrared transceiver. The flow control analyzer receives the dial number output from the keypad unit, and establishes program instructions for controlling the mobile phone to dial an input telephone number. The communications protocol controller receives the program instructions from the flow control analyzer, and configures the same into a format that complies with a predetermined infrared communications protocol. The infrared transceiver establishes an infrared transmission link with the mobile phone, and transmits the program instructions configured by the controller to the mobile phone.

### BACKGROUND OF THE INVENTION

1. Field of the Invention

The invention relates to a telephone accessory, more particularly to a number dialing kit for mobile phones that are capable of infrared data transmission.

2. Description of the Related Art

As shown in FIG. 1, vehicles are equipped with a hands-free apparatus 2 so that drivers can concentrate on road conditions while using a mobile phone 1. However, when making a phone call, the driver is still required to press a series of numeric keys 102 on a keypad 101 of the mobile phone 1. Since the mobile phone 1 is disposed on a seat 3, which is at a distance from the steering wheel 4, it is not easy for the driver to operate the keypad 101 and keep his eyes on the road conditions at the same time. For this reason, vehicular accidents can still occur even when vehicles are equipped with the conventional hands-free apparatus 2.

While some mobile phones are provided with a voice-activated dialing capability, voice-activated dialing is permitted only for a predefined set of telephone numbers and only after a hot key on the mobile phone has been operated. If the telephone number to be dialed is not in the predefined set, there is still a need to operate the keypad of the mobile phone.

A conventional number dialing kit has been proposed heretofore to overcome the aforesaid drawbacks. The number dialing kit includes a keypad unit having a plurality of keys distributed along a steering wheel, and a relay device connected electrically to the mobile phone. Dial signals are wirelessly transmitted from the keypad unit to the relay device. The relay device receives the dial signals, and drives the mobile phone for dialing an input telephone number. As such, the driver is able to input a telephone number while keeping his eyes on the road conditions. However, because different mobile phones by various manufacturers have different electrical interfaces, different corresponding relay devices must be prepared, thereby resulting in troublesome manufacturing process and raw material management. Furthermore, because of the plug-and-socket connection between the relay device and the mobile phone, the out-of-order rate is rather high.

### SUMMARY OF THE INVENTION

Therefore, the object of the present invention is to provide a number dialing kit for a mobile phone with an infrared data transmission capability and that can overcome the aforesaid drawbacks of the prior art.

Accordingly, the number dialing kit of this invention comprises a keypad unit and a processor unit.

The keypad unit is operable so as to generate a dial number output corresponding to an input telephone number.

The processor unit is coupled to the keypad unit, and includes a flow control analyzer, a communications protocol controller and an infrared transceiver. The flow control analyzer receives the dial number output from the keypad unit, and is operable so as to establish a set of program instructions for controlling the mobile phone to dial the input telephone number. The communications protocol controller receives the set of program instructions from the flow control analyzer, and configures the set of program instructions into a format that complies with a predetermined infrared communications protocol. The infrared transceiver is used for establishing an infrared transmission link with the mobile phone, and is operable so as to wirelessly transmit the set of program instructions configured by the communications protocol controller to the mobile phone.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic view showing a vehicle dashboard with a conventional hands-free apparatus;

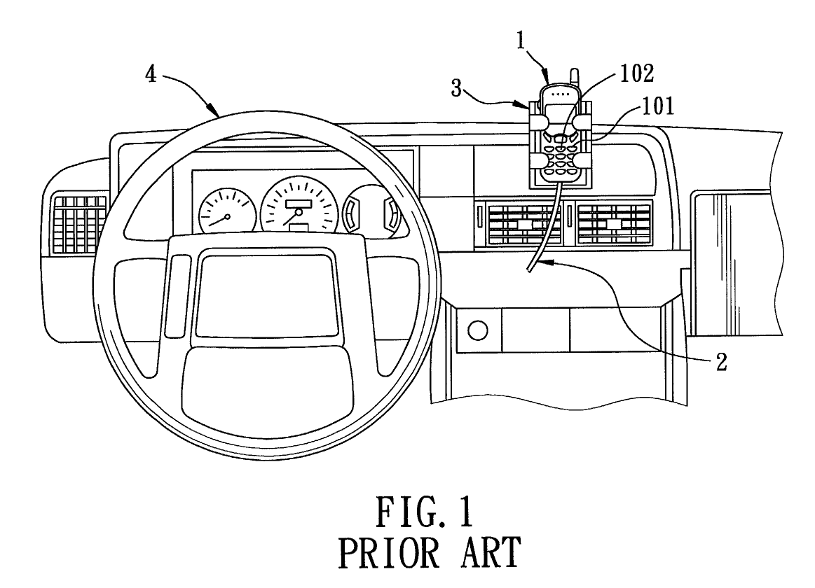

FIG. 2 is a block diagram illustrating the first preferred embodiment of a number dialing kit according to the present invention;

FIG. 3 illustrates the first preferred embodiment in a state of use;

FIG. 4 is a block diagram illustrating the second preferred embodiment of a number dialing kit according to the present invention;

FIG. 5 illustrates the second preferred embodiment in a state of use; and

FIG. 6 illustrates the third preferred embodiment of a number dialing kit according to the present invention.

### DETAILED DESCRIPTION OF THE PREFERRED EMBODIMENTS

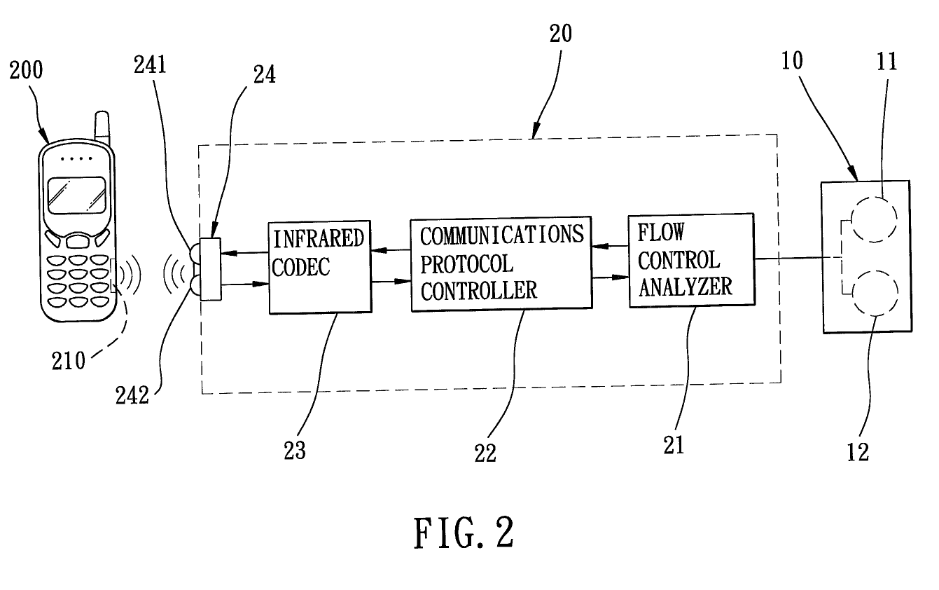

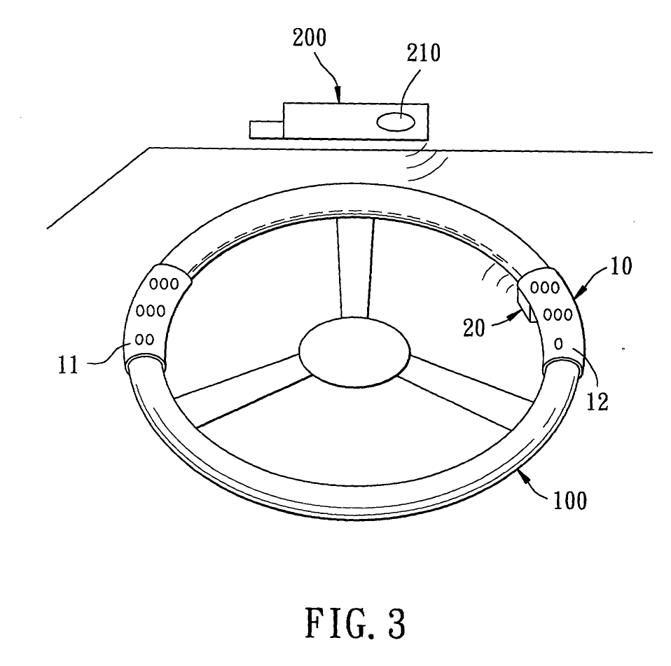

Referring to FIGS. 2 and 3, the first preferred embodiment of a number dialing kit of this invention is adapted for use with a mobile phone 200 that is capable of infrared data transmission in accordance with the Infrared Data Association (IrDA) communications protocol. The number dialing kit includes a keypad unit 10 and a processor unit 20 connected to the keypad unit 10.

The keypad unit 10 of this embodiment is formed as a thin-film touch-triggered key switch unit, and includes a pair of keypads 11, 12 mounted respectively on left and right hand gripping sections of a steering wheel 100. The keypad 11 includes dialing keys 1-5, whereas the keypad 12 includes dialing keys 6-0. The keypads 11, 12 further include function keys, e.g. * key, # key, smart key, and volume adjusting keys, and are connected electrically to each through control wires. The keypad unit 10 is operable so as to generate a dial number output corresponding to an input telephone number.

In this embodiment, the processor unit 20 is integrated into one of the keypads 11, 12 so as to be disposed on the steering wheel 100. The processor unit 20 includes a flow control analyzer 21, a communications protocol controller 22, an infrared codec (coder/decoder) 23, and an infrared transceiver 24. In view of the wired connection between the keypad unit 10 and the processor unit 20, the flow control analyzer 21 can receive the dial number output from the keypad unit 10. The flow control analyzer 21 is operable so as to establish a set of program instructions for controlling the mobile phone 200 to dial the input telephone number. The communications protocol controller 22 is connected to the flow control analyzer 21, receives the set of program instructions from the flow control analyzer 21, and configures the set of program instructions into a format that complies with the IrDA communications protocol. The infrared codec 23 is connected to the communications protocol controller 22, and encodes and amplifies the set of program instructions that were configured by the communications protocol controller 22. The infrared transceiver 24 is connected to the infrared codec 23, is operable so as to establish an infrared transmission link with the mobile phone 200, and has an infrared transmitter 241 for wirelessly transmitting the set of program instructions encoded by the infrared codec 23 to a corresponding transceiver 210 of the mobile phone 200.

In use, the driver must first place the mobile phone 200 at a location suitable for establishing the infrared transmission link with the infrared transceiver 24 before moving the vehicle. The mobile phone 200 is then turned on to allow the mobile phone 200 to execute a handshaking operation with the communications protocol controller 22 of the processor unit 20 via the infrared transmitter 241 and an infrared receiver 242 of the infrared transceiver 24 and the corresponding transceiver 210 of the mobile phone 200. Once the handshaking task has been completed, the keypads 11, 12 can be operated to generate a dial number output, which is processed and subsequently transmitted by the processor unit 20 to enable the mobile phone 200 to begin a dialing operation for dialing an input telephone number without the need for operating the keypad of the mobile phone 200.

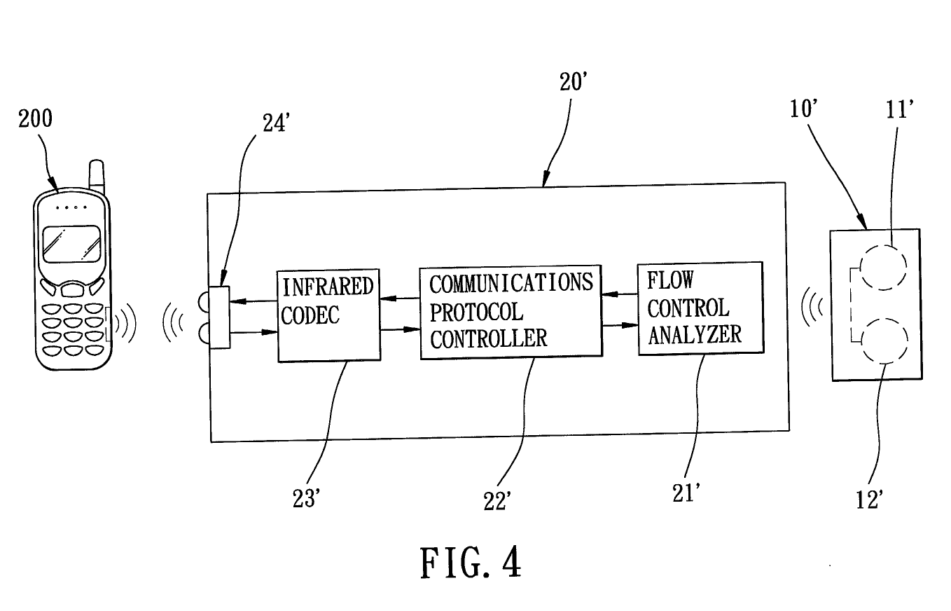

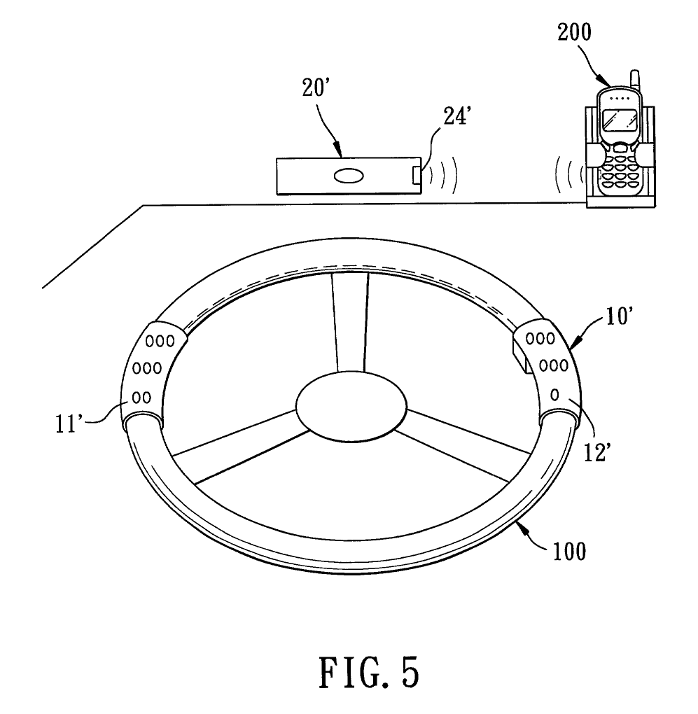

FIGS. 4 and 5 illustrate the second preferred embodiment of a number dialing kit according to this invention. Like the previous embodiment, the number dialing kit also includes a keypad unit 10′ and a processor unit 20′.

The keypad unit 10′ is similar to that of the previous embodiment, and includes a pair of keypads 11′, 12′ mounted respectively on left and right hand gripping sections of a steering wheel 100.

However, unlike the previous embodiment, the processor unit 20′ is not integrated into either of the keypads 11′, 12′ such that the keypad unit 10′ and the processor unit 20′ can be mounted on separate locations in a vehicle. The processor unit 20′ is wirelessly coupled to the keypad unit 10′, and is thus capable of establishing a wireless communications link with the same so as to be able to receive the dial number output therefrom. Alternatively, the processor unit 20′ can have a wired connection with the keypad unit 10′ to achieve the same effect. Like the processor unit 20 of the previous embodiment, the processor unit 20′ also includes a flow control analyzer 21′, a communications protocol controller 22′, an infrared codec 23′, and an infrared transceiver 24′, which function in the same manner as described in the previous embodiment.

Aside from having the advantages of the first preferred embodiment, the number dialing kit of this embodiment offers greater flexibility in terms of the position of the mobile phone 200 in the vehicle.

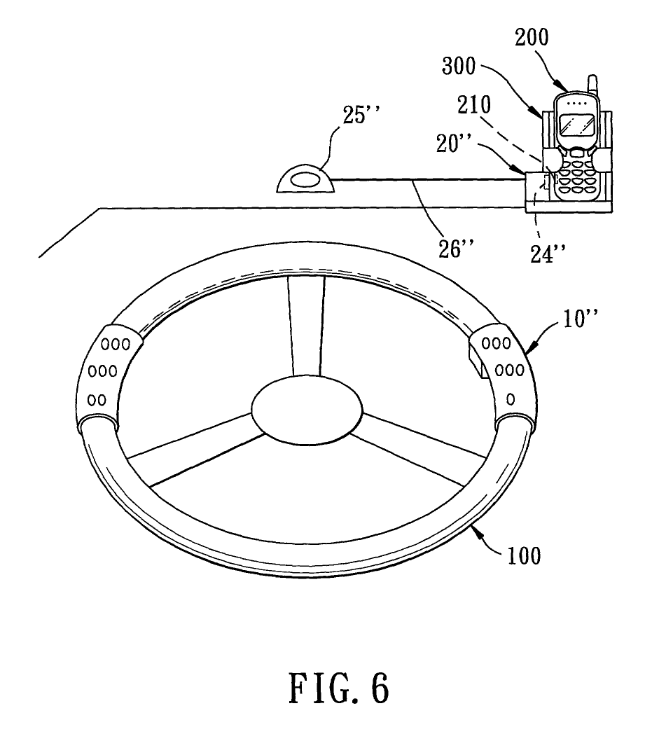

FIG. 6 illustrates the third preferred embodiment of a number dialing kit according to this invention. Unlike the second preferred embodiment, the processor unit 20″ is integrated into a seat 300 for the mobile phone 200 such that the infrared transceiver 24″ of the processor unit 20″ is disposed proximate to the corresponding transceiver 210 of the mobile phone 200 when the latter is disposed on the seat 300. The processor unit 20″ is connected to another infrared transceiver 25″ via a cable 26″. Wireless coupling between the processor unit 20″ and the keypad unit 10″ on the steering wheel 100 is thus established via the infrared transceiver 25″.

It has thus been shown that the number dialing kit of this invention has the advantages of a relatively simple structure and ease of manufacture and installation. Furthermore, use of a mobile phone together with the number dialing kit of this invention can promote driver safety and reduce the occurrence of vehicular accidents.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A number dialing kit for a mobile phone that is capable of infrared data transmission, said number dialing kit comprising:
a keypad unit operable so as to generate a dial number output corresponding to an input telephone number; and
a processor unit coupled to said keypad unit and including
a flow control analyzer for receiving the dial number output from said keypad unit, and operable so as to establish a set of program instructions for controlling the mobile phone to dial the input telephone number,
a communications protocol controller for receiving the set of program instructions from said flow control analyzer, and operable so as to configure the set of program instructions into a format that complies with a predetermined infrared communications protocol, and
an infrared transceiver for establishing an infrared transmission link with the mobile phone, and operable so as to wirelessly transmit the set of program instructions configured by said communications protocol controller to the mobile phone.

2. The number dialing kit as claimed in claim 1, wherein said processor unit further includes an infrared codec for encoding and amplifying the set of program instructions configured by said communications protocol controller prior to wireless transmission by said infrared transceiver.

3. The number dialing kit as claimed in claim 1, wherein the predetermined infrared communications protocol is the IrDA communications protocol.

4. The number dialing kit as claimed in claim 1, wherein said keypad unit includes a pair of keypads adapted to be mounted respectively on two hand gripping sections of a steering wheel of a vehicle, said keypads having a plurality of dial keys distributed therebetween.

5. The number dialing kit as claimed in claim 1, wherein said processor unit is integrated into said keypad unit.

6. The number dialing kit as claimed in claim 5, wherein said processor unit has a wired connection with said keypad unit.

7. The number dialing kit as claimed in claim 1, wherein said keypad unit and said processor unit are adapted to be mounted on separate locations in a vehicle.

8. The number dialing kit as claimed in claim 7, wherein said processor unit is wirelessly coupled to said keypad unit and is capable of establishing a wireless communications link with said keypad unit so as to be able to receive the dial number output therefrom.
